(19) United States
(12) Patent Application Publication
(10) Pub. No.: US 2007/0083543 A1
(43) Pub. Date: Apr. 12, 2007

(54) XML schema template builder

(75) Inventor: Hui-Min Chen, San Leandro, CA (US)

Correspondence Address: Alfred W. Zaher, Esq.;BLANK ROME LLP, One Logan Square, 130 North 18th Street, Philadelphia, PA, 19103, US

(73) Assignee: Epiphany, Inc., San Mateo, CA (US)

(21) Appl. No.: 11/246,362

(22) Filed: Oct. 7, 2005

(51) Int. Cl. G06F 7/00

(52) U.S. Cl. 707/102

(57) ABSTRACT

A method of creating a template to convert a database schema model to XML using database schema metadata.

### BACKGROUND

1. Field of the Invention

This invention relates to database schema, and more particularly to presenting database schema in a generic format.

2. Description of the Related Art

Data modeling and entity-relationship modeling tools create a proprietary format for storing the models they create. As a proprietary storage format, it is difficult to transfer to other applications and it cannot be manipulated without the originating tool. This is unnecessarily cumbersome. A solution is needed to store data models or entity-relationship models in a generic format without having to access the originating tool.

### BRIEF DESCRIPTION OF THE DRAWINGS

It is to be understood that, in the drawings, like reference numerals designate like structural elements. Also, it is understood that the depictions in the Figures are not necessarily to scale.

FIG. 1A is an exemplary representation of external database tools accessing database schema;

FIG. 1B is an exemplary representation of external database tools accessing database schema without accessing the database schema editing tool;

FIG. 2 is an exemplary flow diagram representing a method of exporting a database schema to XML;

FIG. 3 is an exemplary flow diagram representing a method of importing a modified XML file into a schema editing tool;

FIG. 4 is an exemplary representation of a template;

FIGS. 5A-5C are an exemplary representation of an XML file generated from the template in FIG. 4;

FIG. 6A is an exemplary representation of a capillary object;

FIG. 6B is an exemplary representation of an excerpt of a schema diagram including multiple domains and capillary relationships;

FIG. 7 is an exemplary flow diagram representing capillary relationship management logic;

FIGS. 8A-8B are an exemplary representation of a template configured to traverse the hierarchical and capillary relationships between database objects; and

FIGS. 9A-9C are an exemplary representation of cascade-delete stored procedures for Oracle database generated from the template in FIGS. 8A-8B.

### DETAILED DESCRIPTION

In the following description, numerous specific details are set forth to provide a thorough understanding of the embodiments. It will be apparent, however, to one skilled in the art that the embodiments may be practiced without some or all of these specific details. In other instances, well known process steps have not been explained in detail in order to avoid unnecessarily obscuring the description.

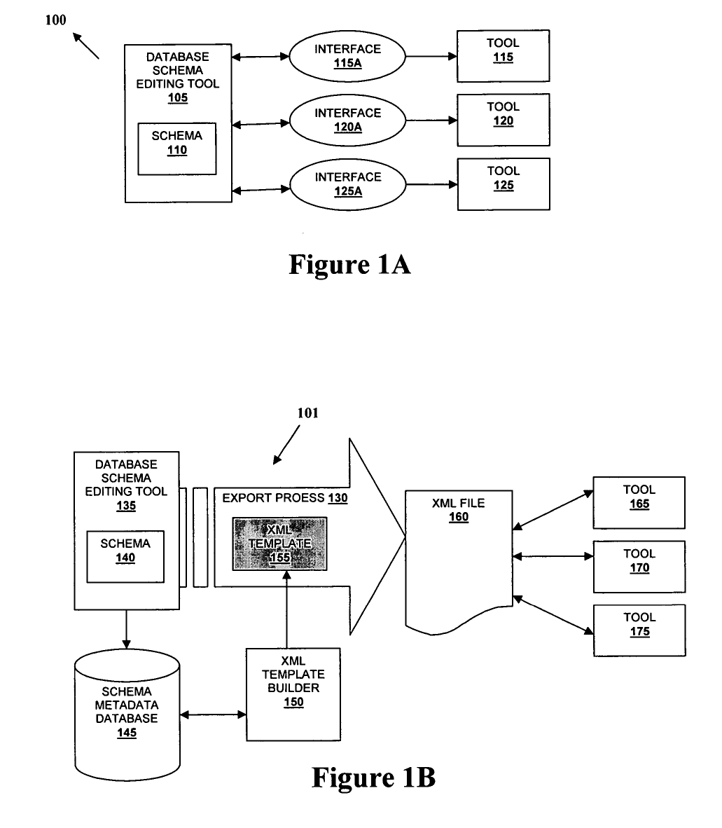

System 100 in FIG. 1A is an exemplary representation of external database tools accessing database schema. Database schema editing tool 105 is used to configure and hold schema 110. Coupled to database schema editing tool 105, are external tools 115, 120, 125. These tools perform distinct functions and may be from a plurality of venders. The tools are coupled to database editing tool 105 via interfaces 115A, 120A, and 125A, respectively. Each tool creates and uses its own interface to communicate with the database schema editing tool 105 and to access the schema 110.

System 101 in FIG. 1B is an exemplary representation of external database tools accessing database schema without accessing the database schema editing tool. Database schema editing tool 135 hold schema 140. Database schema editing tool 135 also stores information about the schema in a schema metadata database 145. The schema metadata database 145 can also be referred to as a meta-metadata database because it stores information about information. XML Template builder 150 accesses schema metadata 145 and outputs an XML template 155. The XML template 155 is used by the database schema editing tool 135 to export the schema 140. The export process 130, exports the schema 140 based on the XML template 155 and results in an XML representation of the database schema, as shown in XML file 160. External tools 165, 170, and 175 access the database schema 140 not via the database editing tool 135 but via the created XML file 160.

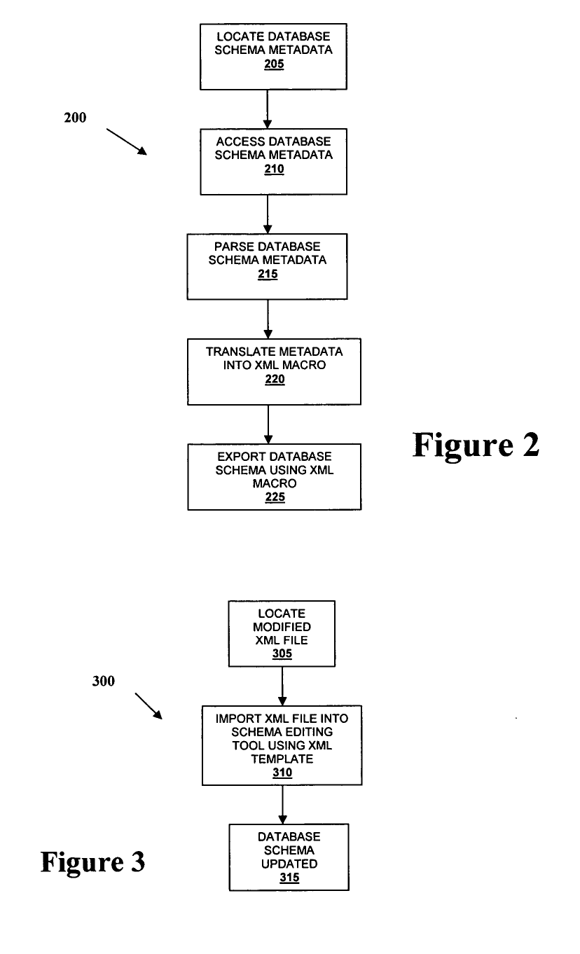

Process 200 in FIG. 2 is an exemplary flow diagram representing a method of exporting a database schema to XML. The discussion of FIG. 2 refers to FIG. 1B. In process action 205 the schema metadata database 145 is located. Process action 210 accesses the located schema metadata database 145. XML template builder 150 parses the schema metadata in process action 215 and translates the metadata into an XML template 155 in process action 220. Database schema editing tool 135 uses the XML template 155 in export process 130 to export the database schema in process action 225. This process action creates an XML representation of the schema in XML file 160.

The XML template 155 may be referred to as the macro file or XML macro. The XML template 155 provides the translation of the schema to XML when connecting to a schema metadata database or when the user exports the database schema from the schema editing tool. The XML template 155 is configured to traverse a set of hierarchical relationships among a plurality of tables, and when utilized, generates cascade delete/update stored procedures. Further the XML template 155 is configured to detect and manage capillary relationships. Management of these relationships is described in the Relationship Management section of this disclosure.

XML file 160 can be manipulated by tools 165, 170, and 175 or by a text editor. An XML file, being an open format, has much improved transportability and versatility versus a database editing tool schema representation. With use of the template 155 and the resulting XML file 160, any XML aware tool can access the database schema without accessing the originating database schema editing tool.

There are many tools that can make use of the XML file. In some embodiments, the tools may be presentations tools to present the schema in another graphical format such as Object-oriented format. Other tools may want to further manipulate the schema to make changes using a tool that is more user-friendly or simpler, than the database schema editing tool. Further, other tools may manipulate the schema in XML for other purposes. For example, the XML file may be translated by a Java program to translate the XML file into SQL scripts for Microsoft SQLServer, Oracle, and DB2 databases.

In some embodiments, the manipulated XML file is used by the database schema editing tool to import the changes into the stored schema. FIG. 3 is an exemplary flow diagram of process 300 representing a method of importing a modified XML file into a schema editing tool. In process action 305, the modified XML file is located. Process action 310 imports the XML file into the database schema editing tool using the XML template. The schema is updated in process action 315. Process 300 allows any changes to the XML file 160 to be incorporated in the originating schema 140 stored in the schema editing tool 135. The editing tool may then propagate the changes to the database environment.

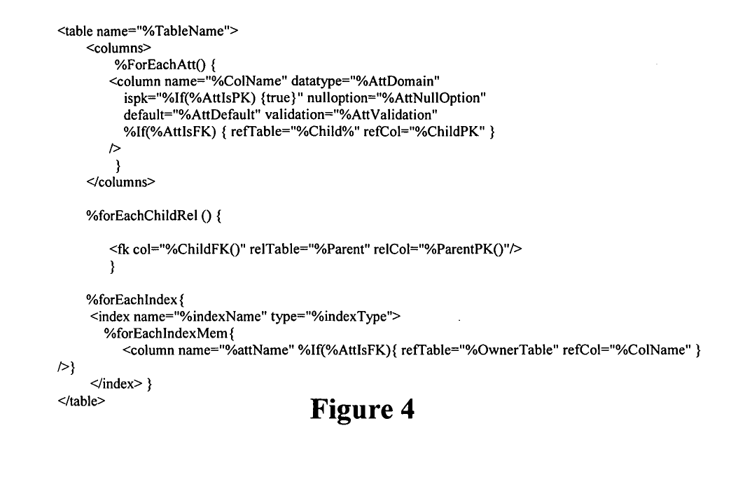

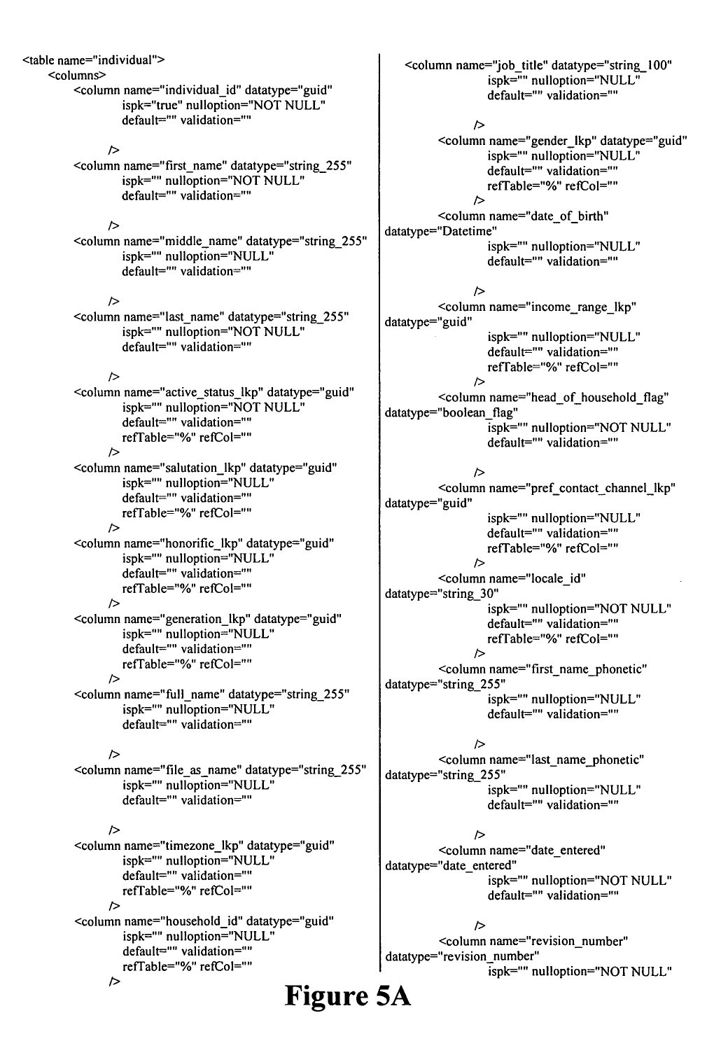

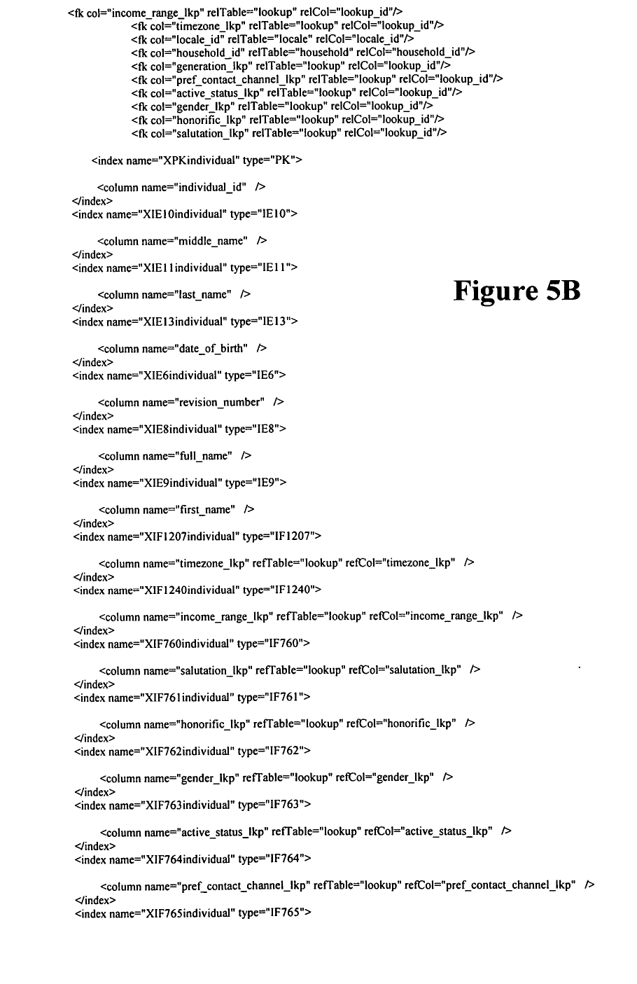

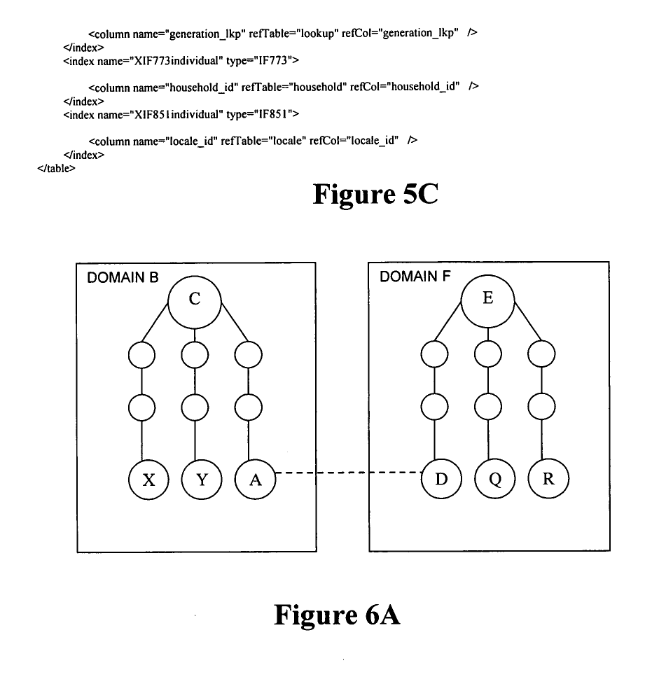

FIG. 4 is an exemplary representation of a template to create an XML representation of a database schema. The resulting XML file generated using this template is shown in FIGS. 5A through 5C.

Relationship Management

Recall the template is configured to traverse a set of hierarchical relationships including capillary relationships among a plurality of tables, and when utilized, generates cascade delete/update stored procedures. Generally speaking, there are three types of objects in terms of data modeling. The first type of object is a leading object. Leading objects are the root objects that do not have relation to other objects in the model. The second type of object depends on the leading object and may become the parents to other dependent objects. There may be, and usually are, multiple dependent objects. Usually, the leading object and its dependent objects form a cluster or domain, altogether representing some concept. The third type of object is called a capillary object. These objects exist at the lowest level of the data model and usually develop a relationship with other objects in another cluster or domain. These capillary objects represent the bridges between domains of information.

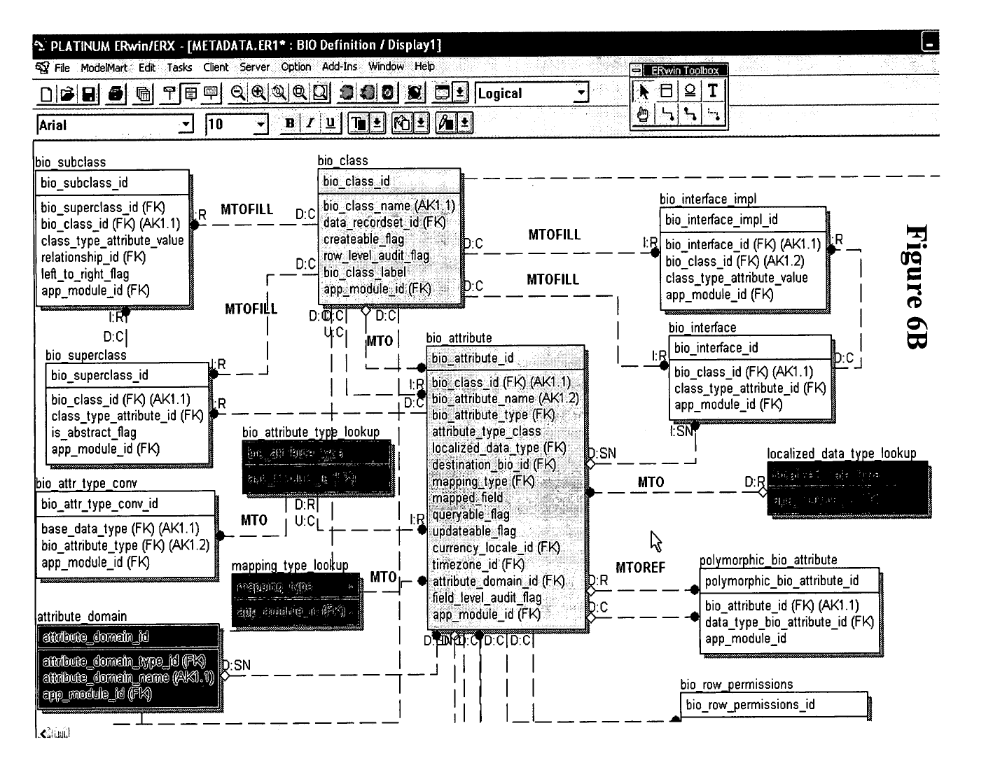

FIG. 6A is an exemplary representation of a capillary object. For example, suppose object A is at the lowest level of domain B which is headed by leading object C. By recursively traversing many-to-one relationships from the leading object C to all its dependent objects, object A can be reached. However, object A may also have a relationship with object D, which depends on the leading object E in a different domain F. In that case, object A is a capillary object which links domains B and F.

Capillary objects pose a challenge while deleting, updating, importing, and exporting objects (or the data they carried) from a domain. For example, suppose it is desired to perform a cascade delete on the leading object C in domain B when a criterion is met. However, dependent object A (that is to be deleted) is also the parent to object D in domain F. If object D and its dependent objects in domain F are deleted, this may result in deleting too many objects in the data model. If object D and/or its dependent objects in domain F are not deleted, the result may be many dangling objects in the model. In the case of exporting a capillary object a determination is made as to whether to export the dependent object from the second domain. The exact set of objects is required in the export so as to restore the relationships in the data model without errors.

To manage capillary objects, the XML template is armed with logic to detect the context while traversing the hierarchical and/or capillary relationships. The XML templates manage the capillary objects such that these bridging relationships can be restored.

FIG. 6B is an exemplary representation of an excerpt of a schema diagram including multiple domains and capillary relationships. The schema objects are illustrated by the rectangle entities. The 4 shading levels represent 4 different domains. The relationships of the objects to one another are shown by the lines connecting the objects and by the nomenclature shown along side the lines. For example, D:C indicates “on delete, cascade”, that is, on a delete operation, cascade the delete to the dependent objects; similarly U:C indicates “on update, cascade”; I:R indicates “on insert, restrict” restrict the insertion to the dependent object when an insertion to the parent object occurs, and D:SN indicates “on delete, set null” that is, when a parent object is deleted, set the reference in the dependent object to null, instead of deleting the dependent object.

In some embodiments, user-defined nomenclature is used to further describe the relationship between the objects. For example, MTO may stand for “many-to-one.” This nomenclature may be used when it is known that the dependent object in the second domain is either static in nature, or can be regenerated by the parent object. In this embodiment there is no need to traverse the capillary relationship as the object is replaceable or static. On the other hand, MTOFILL or “many-to-one, filled” may be used when the second domain object is transient, that is, it cannot exist without its parent object. In this embodiment, the relationships are to be traversed. Lastly, MTOREF or “many-to-one, reference only” refers to those objects that possess a reference-only relationship with the second domain object. That is, the relationship between these objects may be broken and restored at a later point. such that it is not necessary to include the second domain object in the operation. For example, when deleting the parent/capillary object A in domain B, delete its capillary relationship (e.g., a foreign key constraint) to the dependent object D in domain F, but do not delete the dependent object D in domain F.

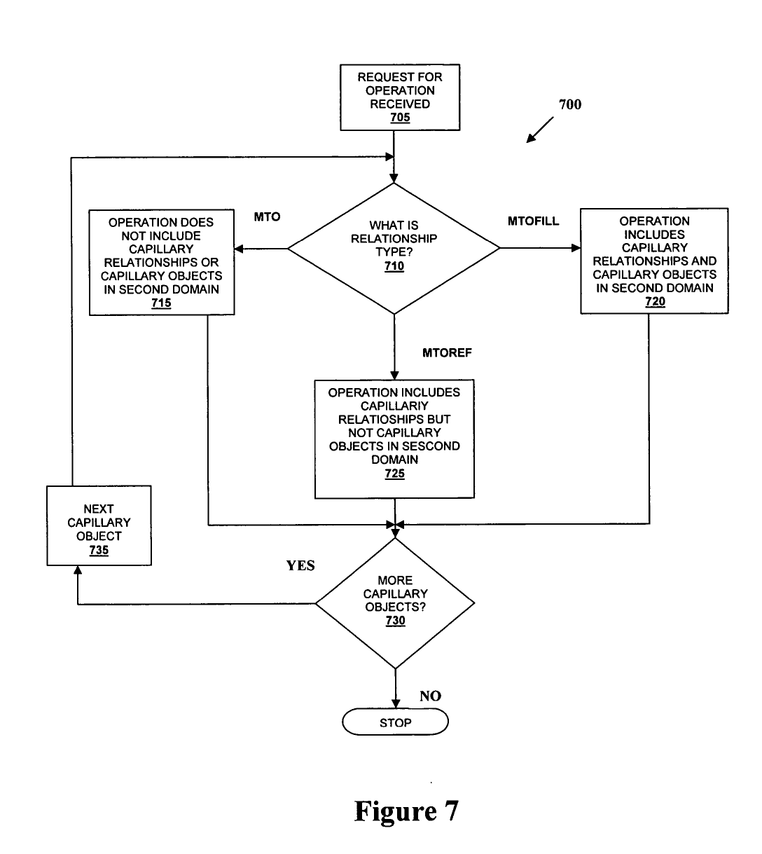

The capillary management logic uses the user-defined nomenclature to determine the appropriate management of capillary objects. FIG. 7 is an exemplary flow chart 700 illustrating the capillary management logic included in the template. When an operation is required, such as delete, export, or import, this logic is initiated. In process action 705 the operation request is received. Process action 710 determines the relationship type between the capillary objects. If the relationship type is many-to-one MTO, that is, if the object in the second domain is static, the operation performed will exclude the related objects from the second domain in process action 715. Because the objects are static or can be replaced by the parent object, it is not necessary to include them. In other words, the capillary relationships and capillary objects are excluded from the operation. If the relationship type is many-to-one, filled, or MTOFILL, and therefore, the dependent object from the second domain is transient and cannot exist without the parent in the first domain, then process action 720 includes the capillary relationship and the dependent objects from the second domain in the operation. If process action 710 determines the relationship type is many-to-one, reference only, or MTOREF, indicating that the dependent object from the second domain merely refers to the capillary object, then process action 725 includes information regarding the capillary relationship but does not include the dependent second domain object in the operation. For example, when exporting the parent/capillary object A in domain B, export its capillary relationship (i.e. a foreign key constraint) to the dependent object D in domain F, but do not export the dependent object D in domain F. These reference-only dependent blocks may be regenerated upon import. Process action 730 determines if there are more capillary objects to check. If yes, process action 735 goes to the next object and returns control of process 700 to process action 710. If there are no more capillary objects to be checked, process 700 stops.

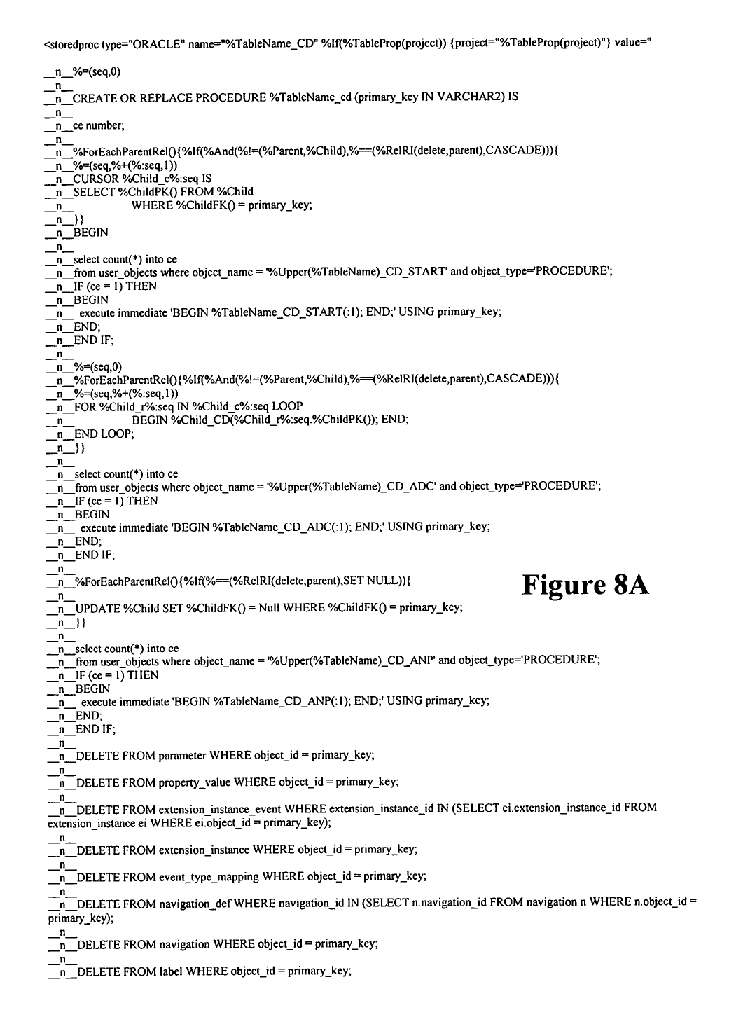

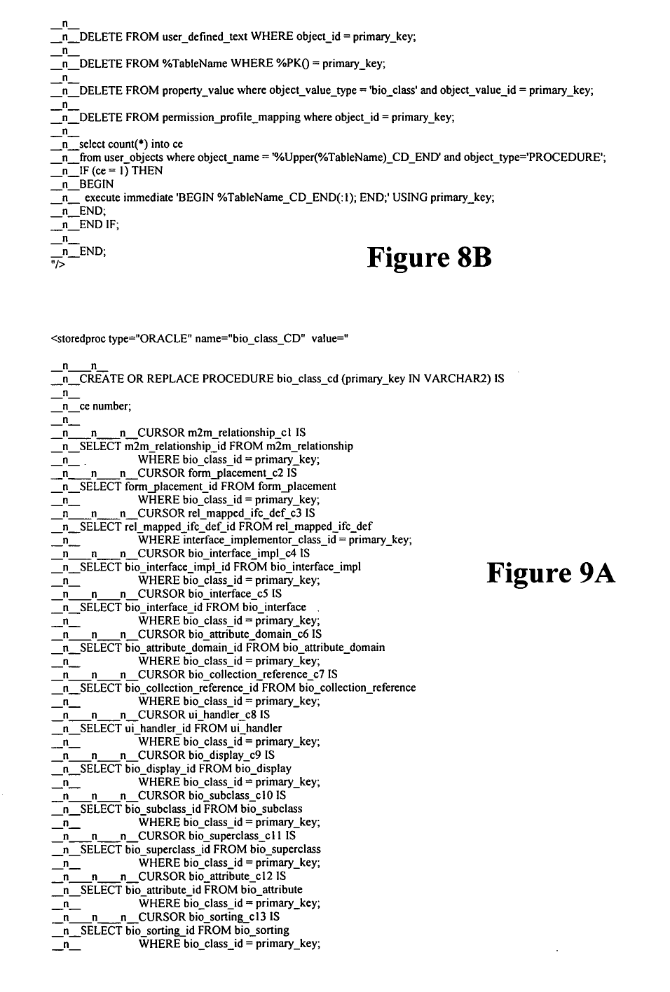

FIGS. 8A and 8B are an exemplary representation of a portion of a template that configured to traverse the hierarchical and capillary relationships between database objects. The particular portion represented here is configured for Oracle databases, however, other database environments are available as well. When this template is utilized, an entity relationship schema model containing capillary objects is converted to an XML file.

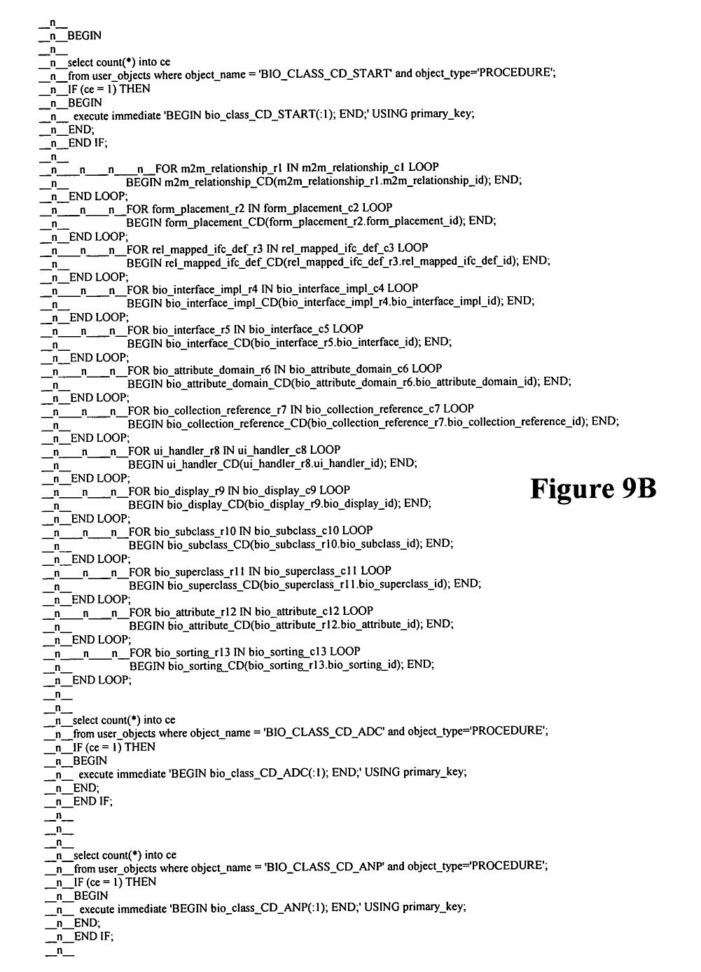

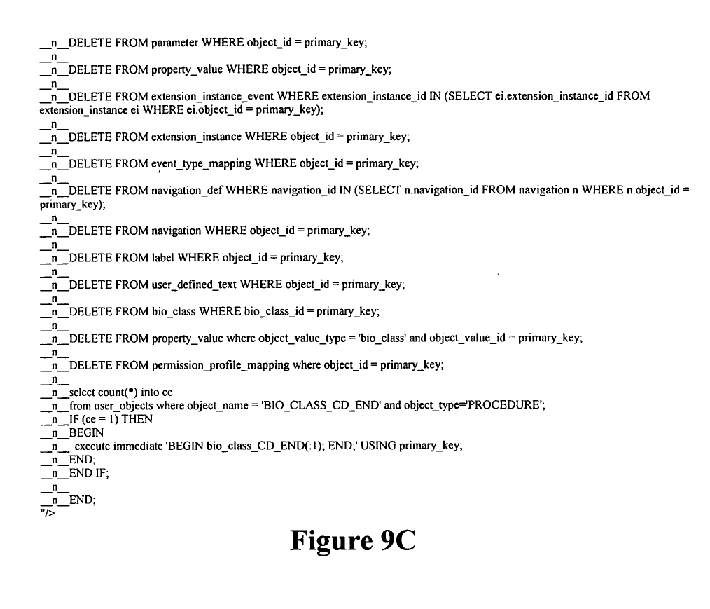

FIGS. 9A-9C are exemplary representations of a portion of an XML file that was generated from the template portion shown in FIGS. 8A and 8B. Based on the information gathered from traversing the hierarchical and capillary relationships between database objects, sophisticated cascade-delete stored procedures are generated. The particular representation in FIGS. 9A-9C shows the creation of Oracle cascade-delete stored procedures, however, stored procedures for other database environments are available as well, including at least DB2 and Microsoft SQLServer.

What is claimed is:

1. A method of exporting a database schema to XML, the method comprising:
locating metadata of a database schema editing tool, the database schema editing tool storing the schema of a database in a proprietary format and storing metadata of the schema in a schema metadata database;
accessing the metadata;
parsing the metadata;
translating the metadata into an XML macro; and
exporting the database schema into XML format using the XML macro.

2. The method of claim 1, wherein translating the metadata comprises configuring the XML macro to traverse a set of hierarchical relationships among a plurality of tables.

3. The method of claim 2, wherein configuring the XML macro to traverse comprises configuring to traverse a capillary object, the capillary object being an object from one domain that has a relationship with an object from a second domain.

4. The method of claim 3, wherein translating the metadata comprises configuring the XML macro to generate cascade delete/update stored procedures.

5. The method of claim 1, wherein translating the metadata comprises configuring the XML macro to generate cascade delete/update stored procedures.

6. The method of claim 1, wherein the XML format is edited using a text editor.

7. The method of claim 6, wherein the edited XML format is presented in an application, the application being external to the database schema editing tool.

8. A computer program product embodied on computer readable medium, the computer readable medium having stored thereon a sequence of instructions which, when executed by a processor, causes the processor to execute a method for exporting a database schema to XML, the method comprising:
locating metadata of a database schema editing tool, the database schema editing tool storing the schema of a database in a proprietary format;
accessing the metadata;
parsing the metadata;
translating the metadata into an XML macro; and
exporting the database schema into XML format using the XML macro.

9. The computer program product of claim 8, wherein translating the metadata comprises configuring the XML macro to traverse a set of hierarchical relationships among a plurality of tables.

10. The computer program product of claim 9, wherein configuring the XML macro to traverse comprises configuring to traverse a capillary object, the capillary object being an object from one domain that has a relationship with an object from a second domain.

11. The computer program product of claim 10, wherein translating the metadata comprises configuring the XML macro to generate cascade delete/update stored procedures.

12. The computer program product of claim 8, wherein translating the metadata comprises configuring the XML macro to generate cascade delete/update stored procedures.

13. The computer program product of claim 8, wherein the XML format is edited using a text editor.

14. The computer program product of claim 13, wherein the edited XML format is presented in an application, the application being external to the database schema editing tool.

15. A template for translating a database schema to XML, the template comprising:
a first item that provides for the creation of tables;
a second item that provides for creation of stored procedures;
a third item that provides for creation of triggers; and
a fourth item that provides for creation of indices.

16. The template of claim 15, further comprising a fifth item that provides for traversing a set of hierarchical relationships among a plurality of tables.

17. The template of claim 15, wherein the stored procedures are cascade delate/update stored procedures.

18. The template of claim 15, further comprising a sixth item that provides for traversing one or more capillary objects, the one or more capillary object being an object from one domain that has a relationship with an object from a second domain.
